(19) United States
(12) Patent Application Publication
(10) Pub. No.: US 2021/0232262 A1
(43) Pub. Date: Jul. 29, 2021

(54) TOUCH PANEL AND MANUFACTURING METHOD THEREOF

(71) Applicant: WUHAN CHINA STAR OPTOELECTRONICS SEMICONDUCTOR DISPLAY TECHNOLOGY CO., LTD., Wuhan, Hubei (CN)

(72) Inventor: Xiaoliang FENG, Wuhan, Hubei (CN)

(21) Appl. No.: 16/301,452

(22) PCT Filed: Sep. 5, 2018
(86) PCT No.: PCT/CN2018/104190

§ 371 Date: Nov. 14, 2018

(30) Foreign Application Priority Data
Aug. 21, 2018 (CN) 201810956559.X

(51) Int. Cl. G06F 3/044

(52) U.S. Cl. CPC G06F 3/0443; G06F 2203/04103; G06F 2203/04111

(57) ABSTRACT

The present disclosure provides a touch panel and a manufacturing method thereof. The touch panel includes a substrate and a touch control part. The touch control part includes a first electrically conductive layer, a second electrically conductive layer bridging the first electrically conductive layer, and an insulating layer disposed between the first electrically conductive layer and the second electrically conductive layer. A light absorbing layer is disposed on one surface of the second electrically conductive layer far away from the substrate, and a pattern of the light absorbing layer projected on the second electrically conductive layer covers a pattern of the second electrically conductive layer.

### BACKGROUND

### Field

The present disclosure relates to a display field, and more particularly to a touch panel and a manufacturing method thereof.

### Background

Touch screens includes on-cell touch panels and in-cell touch panels. In the in-cell touch panels, touch sensing functions are embedded into metallurgy pixels. This can make the touch panels thin and light, and thus the in-cell touch panels are favored by manufacturers.

A touch panel usually includes electrode layers. Bridges are used in intersections of horizontal electrodes and vertical electrodes, so as to avoid short circuits because the horizontal electrodes directly contact the vertical electrodes. The conventional bridges are manufactured of a metal material. When a line width of a bridge is small, a manufacturing cost is increased apparently. When a line width of a bridge is large, the metal material becomes visible in a black screen state due to external light. As such, visual sense of a user to the touch panel is significantly reduced. Consequently, there is a need to solve the above-mentioned problems in the prior art. Consequently, a touch screen and a manufacturing method thereof are urgently required to solve the above-mentioned problem.

### SUMMARY OF THE DISCLOSURE

The present disclosure provides a touch panel and a manufacturing method thereof for solving the problem that a bridge metal layer is visible due to strong reflective light.

According to an aspect of the present disclosure, provided is a touch panel including a substrate and a touch control part disposed on one side of the substrate. The touch control part includes a first electrically conductive layer, a second electrically conductive layer bridging the first electrically conductive layer, and an insulating layer disposed between the first electrically conductive layer and the second electrically conductive layer. A light absorbing layer is disposed on one surface of the second electrically conductive layer far away from the substrate, and a pattern of the light absorbing layer projected on the second electrically conductive layer covers a pattern of the second electrically conductive layer.

According to one embodiment of the present disclosure, the first electrically conductive layer is a touch electrode layer, and the second electrically conductive layer is a bridge layer.

According to one embodiment of the present disclosure, the light absorbing layer is one of a black matrix and a gray coating layer.

According to one embodiment of the present disclosure, a plurality of vias are disposed in the insulating layer, and the bridge layer implements a bridge of the touch electrode layer through the vias.

According to one embodiment of the present disclosure, the touch electrode layer is disposed on one surface of the substrate; the insulating layer is disposed on one surface of the touch electrode layer; the bridge layer is disposed on one surface of the insulating layer; and the light absorbing layer is disposed on one surface of the bridge layer.

According to one embodiment of the present disclosure, the bridge layer is disposed on one surface of the substrate; the light absorbing layer is disposed on one surface of the bridge layer; the insulating layer is disposed on one surface of the light absorbing layer and covers the bridge layer; and the touch electrode layer is disposed on one surface of the insulating layer.

According to one embodiment of the present disclosure, the touch panel further includes a protection layer covering the touch control part.

According to another aspect of the present disclosure, provided is a manufacturing method of a touch panel including: S10, providing a substrate, and forming a touch electrode layer on one surface of the substrate; S20, forming an insulating layer on one surface of the touch electrode layer, disposing a plurality of vias in the insulating layer; S30, forming a bridge layer on one surface of the insulating layer, and implementing a bridge of the touch electrode layer through the vias by the bridge layer; and S40, forming a light absorbing layer on one surface of the bridge layer, and covering a pattern of the second electrically conductive layer by a pattern of the light absorbing layer projected on the second electrically conductive layer; wherein the light absorbing layer is one of a black matrix and a gray coating layer.

According to one embodiment of the present disclosure, the manufacturing method of the touch panel further includes: S50, forming a protection layer covering the light absorbing layer and the insulating layer.

According to yet another aspect of the present disclosure, provided is a manufacturing method of a touch panel including: S10, providing a substrate, and forming a touch electrode layer on one surface of the substrate; S20, forming an insulating layer on one surface of the touch electrode layer, disposing a plurality of vias in the insulating layer; S30, forming a bridge layer on one surface of the insulating layer, and implementing a bridge of the touch electrode layer through the vias by the bridge layer; and S40, forming a light absorbing layer on one surface of the bridge layer, and covering a pattern of the second electrically conductive layer by a pattern of the light absorbing layer projected on the second electrically conductive layer; wherein the light absorbing layer is one of a black matrix and a gray coating layer, and the light absorbing layer is prepared by a screen printing process or an inkjet printing process.

According to one embodiment of the present disclosure, the manufacturing method of the touch panel further includes: S50, forming a protection layer covering the light absorbing layer and the insulating layer.

An advantage of the present disclosure is to provide the touch panel and the manufacturing method thereof. The light absorbing layer is formed by the black matrix or the gray coating layer. The present disclosure has characteristics of a simple process and a low cost and can solve the problem that a bridge metal layer is visible due to strong reflective light.

### BRIEF DESCRIPTION OF THE DRAWINGS

To describe the technical solutions of the embodiments of the present disclosure more clearly, the following briefly introduces the accompanying drawings required for describing the embodiments. Apparently, the accompanying drawings in the following description show only some embodiments of the present disclosure, and those skilled in the art may still derive other drawings from these accompanying drawings without creative efforts.

FIG. 1 illustrates a structural diagram of a bridge substrate in accordance with an embodiment of the present disclosure.

FIG. 2 illustrates a structural diagram of a bridge substrate in accordance with another embodiment of the present disclosure.

FIG. 3 illustrates a structural diagram of a touch panel in accordance with an embodiment of the present disclosure.

FIG. 4 illustrates a structural diagram of a touch panel in accordance with another embodiment of the present disclosure.

FIG. 5 illustrates a structural diagram of a touch panel in accordance with yet another embodiment of the present disclosure.

FIG. 6 illustrates a flow chart of a manufacturing method of a touch panel in accordance with an embodiment of the present disclosure.

### DETAILED DESCRIPTION OF THE PREFERRED EMBODIMENTS

The following embodiments are referring to the accompanying drawings for exemplifying specific implementable embodiments of the present disclosure. Furthermore, directional terms described by the present disclosure, such as upper, lower, front, back, left, right, inner, outer, side, etc., are only directions by referring to the accompanying drawings, and thus the used directional terms are used to describe and understand the present disclosure, but the present disclosure is not limited thereto. In the drawings, elements with similar structures are labeled with like reference numerals.

The present disclosure provides a touch panel and a manufacturing method thereof. Embodiments of the present disclosure can improve the defect that a bridge metal layer is visible due to strong reflective light.

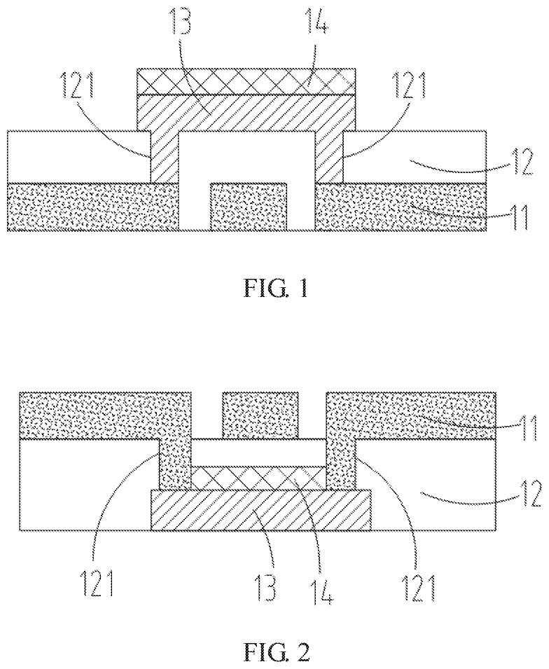

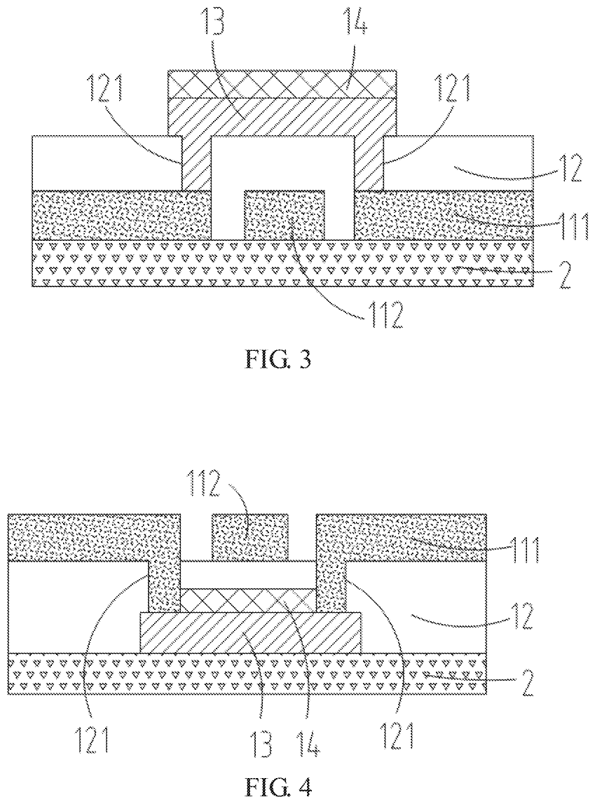

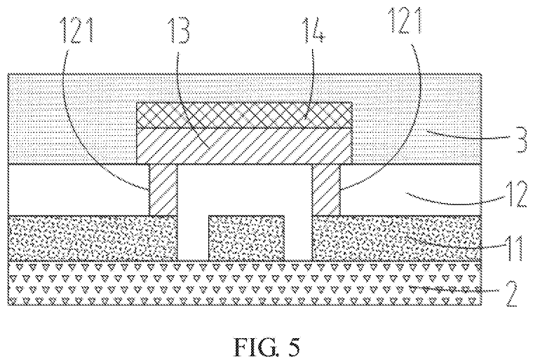

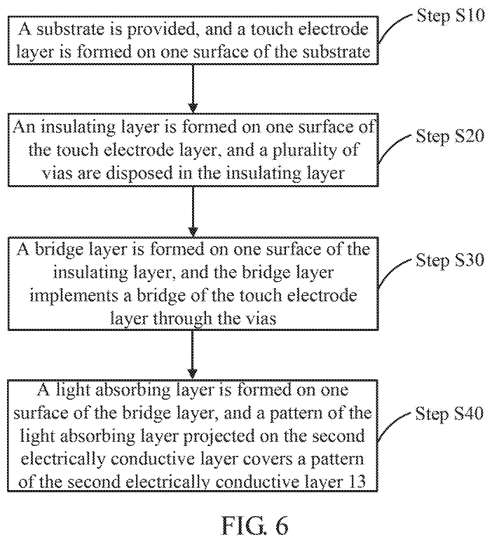

FIG. 1 illustrates a structural diagram of a bridge substrate in accordance with an embodiment of the present disclosure. FIG. 2 illustrates a structural diagram of a bridge substrate in accordance with another embodiment of the present disclosure. FIG. 3 illustrates a structural diagram of a touch panel in accordance with an embodiment of the present disclosure. FIG. 4 illustrates a structural diagram of a touch panel in accordance with another embodiment of the present disclosure. FIG. 5 illustrates a structural diagram of a touch panel in accordance with yet another embodiment of the present disclosure. FIG. 6 illustrates a flow chart of a manufacturing method of a touch panel in accordance with an embodiment of the present disclosure. The present disclosure is further described as follows in conjunction with the drawings and the embodiments.

As shown in FIG. 1 and FIG. 2, the present disclosure provides a bridge substrate including a first electrically conductive layer 11, a second electrically conductive layer 13 bridging the first electrically conductive layer 11, and an insulating layer 12 disposed between the first electrically conductive layer 11 and the second electrically conductive layer 13.

A light absorbing layer 14 is disposed on one side of the second electrically conductive layer 13. A pattern of the light absorbing layer 14 projected on the second electrically conductive layer 13 covers a pattern of the second electrically conductive layer 13.

Usually, the bridge substrate is used for preparation of an array substrate.

The first electrically conductive layer 11 and the second electrically conductive layer 13 may be manufactured of a metal material or any other electrically conductive materials.

It is noted that the first electrically conductive layer 11 includes a plurality of first electrically conductive lines distributed in a horizontal direction and a plurality of second electrically conductive lines distributed in a vertical direction. The first electrically conductive lines and the second electrically conductive lines are distributed in the first electrically conductive layer 11, and the first electrically conductive lines and the second electrically conductive lines are configured to transmit different signals. To avoid signal interferences in a situation that the first electrically conductive lines contact the second electrically conductive lines, the second electrically conductive layer 13 is required to serve as a bridge layer to bridge the first electrically conductive layer 11 when the first electrically conductive lines intersect with the second electrically conductive lines.

Further, in the present disclosure, the light absorbing layer 14 for absorbing light is disposed on the second electrically conductive layer 13 to avoid that the second electrically conductive layer 13 is visible.

Preferably, the light absorbing layer 14 is a black matrix or a gray coating layer, it can be understood that the light absorbing layer 14 is not limited to a black matrix or a gray coating layer. The light absorbing layer 14 may be a light absorbing coating layer which is conveniently prepared.

The black matrix is mainly made of graphite. The graphite has a strong light absorbing function. Usually, an absorbance of the black matrix having a thickness of 4 micrometers (μm) can be greater than 4. Basically, a light reflectance of the black matrix is zero. This means that light intensity reaching the second conductive layer 13 via the black matrix is far less than light intensity of original incident light. Accordingly, light reflected from the second conductive layer 13 and penetrating the black matrix can be ignored. A thickness of the light absorbing layer 14 may be determined according to practical demands when the light absorbing layer 14 is prepared. According to visual sense of human eyes, since a color of the light absorbing layer 14 is consistent with a color of a panel of a device including the bridge substrate in a black screen state, a situation that the second conductive layer 13 is visible can be avoided.

Similarly, the gray coating layer also has light absorbing ability. When the requirement is not strict, the gray coating layer can serve as the light absorbing layer 14. Since the gray coating layer belongs to a dark color, the gray coating layer can avoid that the second conductive layer 13 is visible.

The second conductive layer 13 can be disposed above the first electrically conductive layer 11 as shown in FIG. 1. The second conductive layer 13 also can be disposed below the first electrically conductive layer 11 as shown in FIG. 2. A specific embodiment of the type of the bridge substrate can be selected according to a requirement of bridges.

The bridge substrate may be applied to touch device including a complete bridge layer, an insulating layer, a touch electrode layer and a protection layer. The bridge substrate may also be applied to any other device using the bridge substrate. In the present disclosure, a touch panel using the bridge substrate is further exemplarily described.

According to another aspect of the present disclosure, a touch panel is further provided as shown in FIG. 3 or FIG. 4. The touch panel includes a substrate 2 and a touch control part disposed on one side of the substrate 2. The touch control part includes a first electrically conductive layer 11, a second electrically conductive layer 13 bridging the first electrically conductive layer 11, and an insulating layer 12 disposed between the first electrically conductive layer 11 and the second electrically conductive layer 13.

A light absorbing layer 14 is disposed on one surface side of the second electrically conductive layer 13. A pattern of the light absorbing layer 14 projected on the second electrically conductive layer 13 covers a pattern of the second electrically conductive layer 13.

Preferably, the light absorbing layer 14 is one of a black matrix and a gray coating layer. It can be understood that the light absorbing layer 14 is not limited to a black matrix or a gray coating layer. The light absorbing layer 14 may be a light absorbing coating layer which is conveniently prepared.

Both the black matrix and the gray coating layer can avoid that the second electrically conductive layer 13 is visible. A detailed principle can be referred to an operating principle of the bridge substrate and is not repeated herein.

Further, the first electrically conductive layer 11 is a touch electrode layer. The second electrically conductive layer 13 is a bridge layer. The first electrically conductive layer 11 includes a plurality of touch lines 111 in a first direction and a plurality of touch lines 112 in a second direction. The bridge layer bridging the first touch lines 111 is disposed at positions where the first touch lines 111 intersect with the second touch lines 112. The bridge layer is usually made of an electrically conductive metal. The bridge layer includes a plurality of bridges.

In detail, the insulating layer 12 includes a plurality of vias 121. The bridge layer implements the bridge of the touch electrode layer.

Further, each of the vias 121 includes a first via and a second via. The first via and the second via are respectively positioned at two side of the bridge.

Preferably, as shown in FIG. 3, the touch electrode layer is disposed on one surface of the substrate 2. The insulating layer 12 is disposed on one surface of the touch electrode layer. The bridge layer is disposed on one surface of the insulating layer 12. The light absorbing layer 14 is disposed on one surface of the bridge layer

Further, the bridge layer is filled in the vias 121 on the touch electrode layer.

Preferably, the bridge layer is disposed on one surface of the substrate 2. The light absorbing layer 14 is disposed on one surface of the bridge layer. The insulating layer 12 is disposed on one surface of the light absorbing layer 14 and covers the bridge layer. The touch electrode layer is disposed on one surface of the insulating layer 12.

Further, the touch electrode layer is filled in the vias 121 on the bridge layer.

As shown in FIG. 5, the touch panel further includes a protection layer 3 covering the touch control part.

It can be understood that the substrate 2 further includes common elements of the touch panel, for example, thin film transistors, scan lines, and data lines. These common elements are not repeated herein.

Since the bridge formed by the second electrically conductive layer 13 is far smaller than the touch panel, the bridge formed by the second electrically conductive layer 13 is not visible when the touch panel is in a bright state.

According to yet another aspect of the present disclosure, a manufacturing method of a touch panel is further provided as shown in FIG. 5. The manufacturing method includes the following steps.

In step S10, a substrate is provided, and a touch electrode layer is formed on one surface of the substrate.

In step S20, an insulating layer is formed on one surface of the touch electrode layer, and a plurality of vias are disposed in the insulating layer.

In step S30, a bridge layer is formed on one surface of the insulating layer, and the bridge layer implements a bridge of the touch electrode layer through the vias.

In step S40, a light absorbing layer is formed on one surface of the bridge layer, and a pattern of the light absorbing layer projected on the second electrically conductive layer covers a pattern of the second electrically conductive layer 13.

The light absorbing layer is ono of a black matrix and a gray coating layer. The light absorbing layer is prepared by a screen printing process or an inkjet printing process.

In the prior art, a metal oxide layer or an optical oxide film is disposed on a bridge metal layer, so that a reflectivity of the bridge metal layer is reduced. Compared with the present disclosure, a coating process, an etching process and a stripping process are required in the prior art.

In the present disclosure, a black matrix or a gray coating layer serves as a light absorbing layer. The light absorbing layer is prepared by a screen printing process or an inkjet printing process. Therefore, the manufacturing process of the light absorbing layer can be simplified significantly, absorbing effect of the light absorbing layer can be enhanced, and a situation that the bridge metal layer is visible can be avoided. Furthermore, the black matrix and the gray coating layer used in the present disclosure are low-cost materials. The manufacturing process of the light absorbing layer can be simplified significantly, and the manufacturing cost of the light absorbing layer can be reduced. Moreover, devices for manufacturing the light absorbing layer of the present disclosure are common devices, and thus device investment and the cost of the present disclosure can be reduced. Finally, a bridge structure having a fine line width is not required when the light absorbing layer of the present disclosure is used, and thus the manufacturing cost can be saved.

An advantage of the present disclosure is to provide the touch panel and the manufacturing method thereof. The light absorbing layer is formed by the black matrix or the gray coating layer. The present disclosure has characteristics of a simple process and a low cost and can solve the problem that a bridge metal layer is visible due to strong reflective light.

In summary, although the present disclosure has been provided in the preferred embodiments described above, the foregoing preferred embodiments are not intended to limit the present disclosure. Those skilled in the art, without departing from the spirit and scope of the present disclosure, may make modifications and variations, so the scope of the protection of the present disclosure is defined by the claims.

What is claimed is:

1. A touch panel, comprising a substrate and a touch control part disposed on one side of the substrate, the touch control part comprising a first electrically conductive layer, a second electrically conductive layer bridging the first electrically conductive layer, and an insulating layer disposed between the first electrically conductive layer and the second electrically conductive layer;
wherein a light absorbing layer is disposed on one surface of the second electrically conductive layer far away from the substrate, and a pattern of the light absorbing layer projected on the second electrically conductive layer covers a pattern of the second electrically conductive layer.

2. The touch panel of claim 1, wherein the first electrically conductive layer is a touch electrode layer, and the second electrically conductive layer is a bridge layer.

3. The touch panel of claim 2, wherein the light absorbing layer is one of a black matrix and a gray coating layer.

4. The touch panel of claim 2, wherein a plurality of vias are disposed in the insulating layer, and the bridge layer implements a bridge of the touch electrode layer through the vias.

5. The touch panel of claim 2, wherein the touch electrode layer is disposed on one surface of the substrate;
the insulating layer is disposed on one surface of the touch electrode layer;
the bridge layer is disposed on one surface of the insulating layer; and
the light absorbing layer is disposed on one surface of the bridge layer.

6. The touch panel of claim 2, wherein the bridge layer is disposed on one surface of the substrate;
the light absorbing layer is disposed on one surface of the bridge layer;
the insulating layer is disposed on one surface of the light absorbing layer and covers the bridge layer; and
the touch electrode layer is disposed on one surface of the insulating layer.

7. The touch panel of claim 2, further comprising a protection layer covering the touch control part.

8. A manufacturing method of a touch panel, comprising:
S10, providing a substrate, and forming a touch electrode layer on one surface of the substrate;
S20, forming an insulating layer on one surface of the touch electrode layer, disposing a plurality of vias in the insulating layer;
S30, forming a bridge layer on one surface of the insulating layer, and implementing a bridge of the touch electrode layer through the vias by the bridge layer; and
S40, forming a light absorbing layer on one surface of the bridge layer, and covering a pattern of the second electrically conductive layer by a pattern of the light absorbing layer projected on the second electrically conductive layer;
wherein the light absorbing layer is one of a black matrix and a gray coating layer.

9. The manufacturing method of the touch panel of claim 8, further comprising:
S50, forming a protection layer covering the light absorbing layer and the insulating layer.

10. A manufacturing method of a touch panel, comprising:
S10, providing a substrate, and forming a touch electrode layer on one surface of the substrate;
S20, forming an insulating layer on one surface of the touch electrode layer, disposing a plurality of vias in the insulating layer;
S30, forming a bridge layer on one surface of the insulating layer, and implementing a bridge of the touch electrode layer through the vias by the bridge layer; and
S40, forming a light absorbing layer on one surface of the bridge layer, and covering a pattern of the second electrically conductive layer by a pattern of the light absorbing layer projected on the second electrically conductive layer;
wherein the light absorbing layer is one of a black matrix and a gray coating layer, and the light absorbing layer is prepared by a screen printing process or an inkjet printing process.

11. The manufacturing method of the touch panel of claim 10, further comprising:
S50, forming a protection layer covering the light absorbing layer and the insulating layer.
